(19) United States
(12) Patent Application Publication
(10) Pub. No.: US 2026/0134643 A1
(43) Pub. Date: May 14, 2026

(54) METHODS AND SYSTEMS FOR INPAINTING THREE-DIMENSIONAL SCENES

(71) Applicant: Huawei Technologies Co., Ltd., Shenzhen (CN)

(72) Inventors: Zhihao Shi, Ottawa (CA); Dong Huo, Ottawa (CA); Yuhongze Zhou, Ottawa (CA); Yan Min, Ottawa (CA); Xinxin Zuo, Ottawa (CA); Juwei Lu, North York (CA)

(21) Appl. No.: 19/173,477

(22) Filed: Apr. 8, 2025

Related U.S. Application Data
(60) Provisional application No. 63/719,996, filed on Nov. 13, 2024.

(51) Int. Cl. G06T 19/20; G06T 3/18; G06T 5/77

(52) U.S. Cl. CPC G06T 19/20; G06T 3/18; G06T 5/77

(57) ABSTRACT

Methods and devices for inpainting a three-dimensional scene in response to object removal. A 3D scene is stored in the form of Gaussian splats. When object removal occurs, a never-before-seen (NBS) area may be revealed that requires inpainting as a result of pruning of the Gaussian splats. Object masks are dilated and remapped to the pruned scene to identify pixels bordering the NBS area. A reference image is inpainted and the geography of its NBS area reconstructed using depth prediction and smoothing. The reference image is then warped to other viewpoints and the warped images and their inpainting masks are input to a multi-view restoration model created by modifying a pre-trained diffusion-based inpainting model to use sparse space-time attention layers to ensure consistency among views. Those refined views are then used to refine the pruned 3D Gaussian model.

### CROSS-REFERENCE TO RELATED APPLICATIONS

The present application claims priority to U.S. Provisional Patent Application No. 63/719,996 filed Nov. 13, 2024, the contents of which are hereby incorporated by reference.

### TECHNICAL FIELD

The present application relates to inpainting of a scene to facilitate object removal and, in particular, inpainting of a three-dimensional scene.

### BACKGROUND

A growing number of applications utilize or enable the use of three-dimensional (3D) scenes. Many 3D scenes may be captured by taking a series of images from different viewpoints around a subject area. 3D scenes can be represented from a series of two-dimensional (2D) images using, for example, a neural radiance field (NeRF) model or Gaussian splatting.

In many situations, a captured 3D scene may include one or more objects that a user may want to remove for one reason or another. As with 2D images, when an object is removed the revealed portion of the image needs to be inpainted. In the case of a 3D scene, inpainting presents an even greater challenge. NeRF-based methods of inpainting are constrained to inpainting entire object regions rather than just the newly exposed parts of the scene after object removal. In the case of 3D scenes, an object mask in one viewpoint/image is typically much larger than the actual area in need of inpainting.

Some existing inpainting techniques for 3D scenes result in blurry scenes or may result in “floaters” in some views. Some techniques are effective for front-facing scenes, but struggle with consistency and structure in other views.

It would be advantageous to provide for improved methods and devices for inpainting three-dimensional scenes.

### SUMMARY

In accordance with one aspect, the present application describes a method of object removal for a three-dimensional scene. The method may include pruning a set of Gaussian primitives to remove an object from the three-dimensional scene using object masks from a plurality of viewpoints, thereby producing a pruned set of Gaussian primitives; re-mapping the object masks from the plurality of viewpoints using the pruned set of Gaussian primitives to determine an inpainting mask area resulting from object removal; inpainting a reference image from one of the plurality of viewpoints to obtain an inpainted reference image; reconstructing a geometry within the inpainting mask area of the inpainted reference image; warping the inpainted reference image to other viewpoints of the plurality of viewpoints to generate a set of warped images; refining the set of warped images using a multi-view restoration model to produce a set of refined images; and refining the pruned set of Gaussian primitives using the set of refined images to produce an inpainted set of Gaussian primitives for the three-dimensional scene.

In some implementations, the re-mapping includes dilating the object masks prior to re-mapping them to the pruned set of Gaussian primitives. In some cases, the re-mapping includes initializing a learnable parameter for each Gaussian primitive that indicates whether its associated Gaussian primitive is included in the inpainting mask area. The re-mapping may include rendering each object mask from its associated viewpoint with the pruned set of Gaussian primitives, optimizing across all viewpoints to update the learnable parameter for the Gaussian primitives based on correspondence between each object mask and the Gaussian primitives, and, based on the updated learnable parameters determining which Gaussian primitives from the pruned set of Gaussian primitives define the inpainting mask area.

In some implementations, reconstructing the geometry within the inpainting mask area of the reference image includes performing a depth prediction within the inpainting mask area and smoothing the depth prediction with depth values in areas adjacent to the inpainting mask area. In some cases, the depth prediction includes using a momencular depth estimator to estimate depths of the inpainting mask area of the inpainted reference image and applying a divergence minimization calculation to smooth the estimated depths with the depth values in areas adjacent to the inpainting mask area.

In some implementations, warping includes warping the inpainted reference image masked by an inpainting mask selecting the inpainting mask area.

In some implementations, refining the set of warped images using the multi-view restoration model includes modifying a pre-trained diffusion-based inpainting model to replace a self-attention layer in a transformer block with a space-time attention layer to result in the multi-view restoration model. In some cases, the space-time attention layer is a sparse space-time attention layer that ensures alignment between two or more adjacent ones of the warped images in an order. The order of the warped images may be shuffled during one or more rounds of inference.

In some cases, an input to the multi-view restoration model includes the set of warped images and a corresponding set of inpainting masks defining the inpainting mask area from each of the viewpoints.

In another aspect, the present application describes a system for object removal for a three-dimensional scene, the system including one or more computing devices having one or more processors and memory, the memory storing processor-executable instructions that, when executed by the one or more processors, are to cause the one or more processors to carry out the operations of one or more of the methods described herein.

In yet a further aspect, the present application describes a computer-readable medium storing computer-executable instructions that, when executed by one or more processors, are to cause the one or more processors to carry out any one or more of the methods described herein.

In another aspect, the present application describes a computer program comprising instructions which, when executed by a computing device, are to cause the computing device to carry out any one or more of methods described herein.

In a further aspect, the present application describes a computing device having means to perform any one or more of the methods described herein.

Other aspects and features of the present application will be understood by those of ordinary skill in the art from a review of the following description of examples in conjunction with the accompanying figures.

### BRIEF DESCRIPTION OF THE DRAWINGS

Reference will now be made, by way of example, to the accompanying drawings in which:

FIG. 1 shows, in flowchart form, one example method of inpainting a three-dimensional scene;

FIG. 2 illustrates object masking of a three-dimensional scene;

FIG. 3 illustrates a process of determining an inpainting mask area and creating inpainting masks;

FIG. 4 shows, in flowchart form, an example method of determining an inpainting mask area and creating inpainting masks;

FIG. 5 shows, in flowchart form, one example method of reconstructing geometry of an inpainting mask area;

FIG. 6 illustrates an example multi-view restoration process;

FIG. 7 shows a high-level diagram of an example computing device; and

FIG. 8 shows a simplified example of software components within the computing device.

Like reference numerals are used in the drawings to denote like elements and features.

### DETAILED DESCRIPTION OF ILLUSTRATIVE EMBODIMENTS

The present application proposes methods and devices for inpainting 3D scenes due to object removal where the 3D scene is represented by way of Gaussian splatting. When an object is removed from a 3D scene, it typically results in revealing of a “never-before-seen” (NBS) region that is under-constructed and requires inpainting.

The 3D models generated by Gaussian splatting are stored as a collection of Gaussian splats or primitives. In some contexts, the terms Gaussian splats, Gaussian splat model, and Gaussian primitives may be used interchangeably. In use, these Gaussian splats or primitives are rasterized to generate a 2D image for viewing by a user from a particular viewpoint.

Gaussian splatting represents a 3D scene as a collection of multivariate Gaussian primitives:

$$= {( {μ}_{m} , {\sum }_{m} , {Γ}_{m} , {SH}_{m} )}_{m = 1}^{M} ,$$

where μₘ, Σₘ, Γₘ, and SHₘ denote the mean vector, covariance matrix, opacity, and spherical harmonic coefficients of a multivariate Gaussian, respectively. A view is synthesized by point-based rendering where a single pixel colour is computed by sorting the primitives' 2D projection in depth order and alpha-blending the contribution of each primitive:

$$C = {\sum }_{m} {c}_{m} {α}_{m} {\prod }_{j = 1}^{m - 1} ( 1 - {α}_{j} )$$

In the above expression, C is the output pixel colour, cₘ is the pre-computed colour of the m-th primitive, and αₘ is the calculated opacity based on distance from the center to the interaction point.

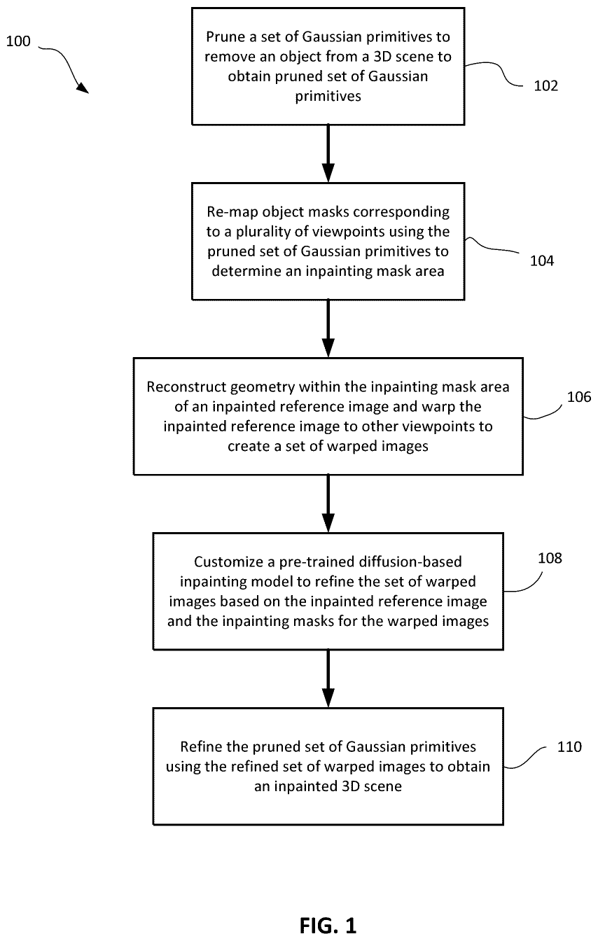

Reference is first made to FIG. 1, which shows, in flowchart form, one example method 100 for inpainting of a 3D scene.

The removal of an object from a 3D scene may be carried out using object masks from different viewpoints. That is, each viewpoint corresponds to a rendered 2D image of the scene and a viewpoint-specific object mask defining the location of the object may be associated with that viewpoint and that image. The object is then removed from the scene through pruning of the set of Gaussian primitives to extract those primitives that correspond to the object, as indicated by operation 102. This pruning results in a pruned set of Gaussian primitives, and potentially exposes an NBS region that is not otherwise visible in any of the viewpoints. This is the region that is in need of inpainting in order to repair the 3D scene.

The object masks themselves are overinclusive of the area in need of repair. That is, from any one viewpoint the corresponding object mask covers both the area in need of inpainting and adjacent areas that are likely well-defined from other viewpoints. Accordingly, in operation 104, the object masks are remapped to the pruned set of Gaussian primitives. In particular, the re-mapping identifies neighbouring pixels or primitives that surround the area in need of inpainting. This results in identifying the under-constructed area and excludes the areas that are within only some of the object masks but that are excluded from other object masks. The re-mapping determines an inpainting mask area. The re-mapping may result in a set of inpainting masks that define the inpainting mask area from the plurality of viewpoints.

In operation 106, geometric reconstruction is performed in within the inpainting area. In particular, a reference image is inpainted from one of the plurality of viewpoints to obtain an inpainted reference image. Within the reference image, the geometry of the NBS area is reconstructed. That inpainted reference image, or at least the inpainting mask area of the inpainted reference image, is then warped to other viewpoints, thereby resulting in a set of warped images. As will be described further below, in some implementations, the geometric reconstruction includes performing depth prediction with regard to the inpainted area of the inpainted reference image. The predicted depth values may be smoothed so as to blend them with depth values in areas adjacent to the inpainting mask area. The warped inpainting that appears in the warped images is likely to have anomalies or imperfections. Accordingly, the method 100 further includes multi-view refinement and restoration.

In operation 108, a multi-view restoration model may be used to refine the set of warped images. The multi-view restoration model may be realized through customization of a pre-trained diffusion-based model. The model may take the set of warped images and the inpainted reference image as inputs. The warped images may be input as masked images in some cases, i.e. the warped images and their corresponding inpainting masks. The model may output refined warped images.

To ensure consistency across all the warped images, the self-attention layer in each transformer block of the pre-trained diffusion-based model may be replaced with space-time attention to correlate across views. In some cases, the space-time attention may be sparse space-time attention that takes into account neighbouring images. The attention layer may also align with the inpainted reference image. The order of the images may be shuffled during the denoising steps in some cases to break the sequential constraint of sparse attention.

In operation 110, the refined warped images are then used to refine the pruned Gaussian primitives, i.e. to fine-tune the pruned 3D scene.

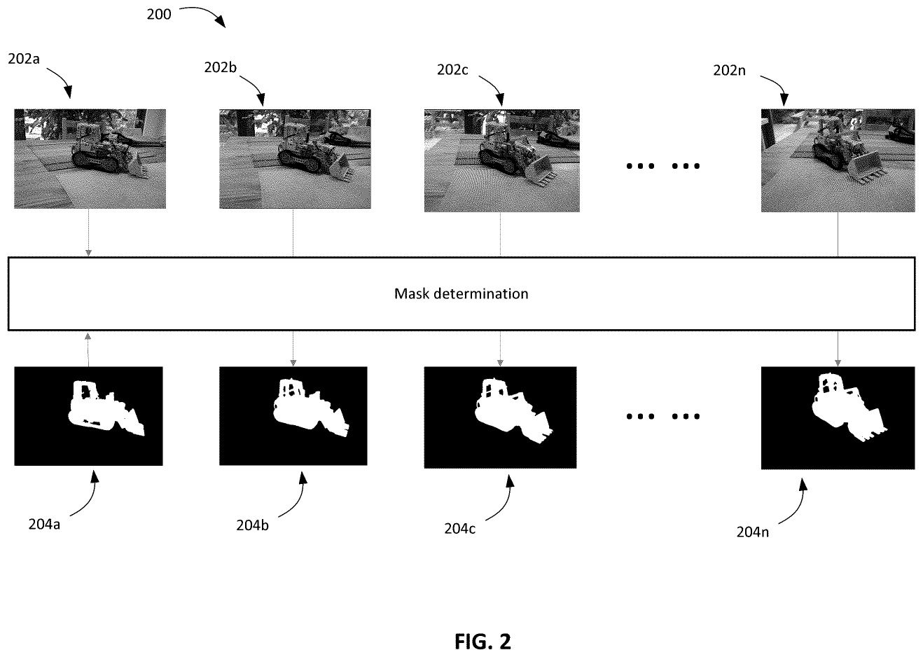

Reference will now be made to FIG. 2, which illustrates object masking of a 3D scene. A 3D scene defined by Gaussian splats, e.g. a set of Gaussian primitives [symbol] , may be generated from a set of training images

$${\{ {I}_{n} \}}_{n = 1}^{N} ,$$

each taken from an associated camera pose or viewpoint. In FIG. 2, images 202a, 202b, 202c, . . . , 202n (collectively, 202) are a set of images defining a scene in which an object is located.

To remove an object from the scene, an object recognition/segmentation operation may be performed. The object may be identified semantically, such as by way of a label or text or speech input. It may be identified through user selection of a point within the object in one of the images 202 or user input of region identifying the object, e.g. circling or otherwise inputting a signal identifying the object, by touch interface or other user input. In each of the images 202, the object is segmented. That is, an object segmentation operation is performed to generate a corresponding object mask 204. In some cases, a machine learning model, such as the Segment Anything Model from MetaAI or another such zero-shot segmentation operation may be used.

Irrespective of the technique used, each of the training images 202 has a corresponding object mask 204 (indicated individually as 204a, 204b, 204c, . . . , 204n). The object masks 204 are a matrix or image that identify the boundaries of the object within the corresponding image 202. In some cases, the object mask 204 may be a binary mask indicating whether pixels correspond to the object or not. Two-dimensional object removal is straightforward; one need only remove the pixels corresponding to the object mask 204 and then perform inpainting. However, three-dimensional object removal is more complex.

To perform object removal from a Gaussian 3D model, each Gaussian primitive is appended with a learnable parameter,

$${\{ {p}_{m} \}}_{m = 1}^{M} ∈ [ 0 , 1 ] ,$$

initialized to 0.5. The learnable parameter indicates whether its corresponding Gaussian primitive belongs to the object to be removed or not. To compute the value of the learnable parameter for each Gaussian, the object masks are mapped back to the Gaussian primitives from each viewpoint. That is, the system determines which Gaussian primitives are inside or outside the masked area from each viewpoint. Through optimization, the learnable parameters are updated until they indicate by their values which primitives are part of the object to be removed and which are not.

In one example, a set of rendered object masks

$${\{ {\hat{M}}_{n} \}}_{n = 1}^{N}$$

is rendered using α′ rendering (similar to colour rendering) from each viewpoint, but replacing cₘ with pₘ. The learnable parameter pₘ is updated over K₁ iterations of optimization with respect to [symbol] loss between

$${\{ {\hat{M}}_{n} \}}_{n = 1}^{N} and {\{ {M}_{n} \}}_{n = 1}^{N} .$$

Other parameters remain unchanged during this procedure.

Once the Gaussian primitives are identified that form the object-to-be-removed, then the set of Gaussian primitives may be pruned to remove them, resulting in a pruned scene [symbol] . In some cases, the pruning may be based on comparing pₘ values with a threshold value. The threshold value may be 0.5 in some cases.

As described above, the resulting pruned scene [symbol] , may be damaged through the pruning in that removal of some of the Gaussian primitives may expose NBS regions in some viewpoints that are under-constructed, underdefined, and/or exhibit artifacts.

To fix the exposed area, the system first determines the inpainting mask area.

Since the inpainting masks correspond to the NBS region in 3D, one option is to detect the NB region and then project it back to 2D; however, the NBS region is usually under-constructed and lacks substantial meaningful Gaussians, making it challenging to detect. Accordingly, the present application proposes localizing the NBS region by leveraging its neighbouring Gaussians.

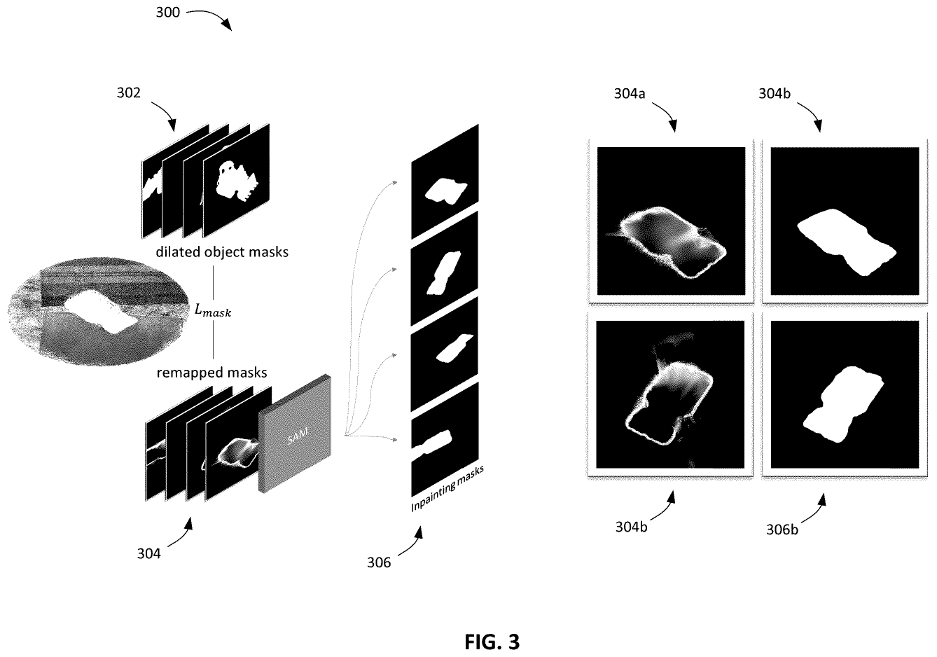

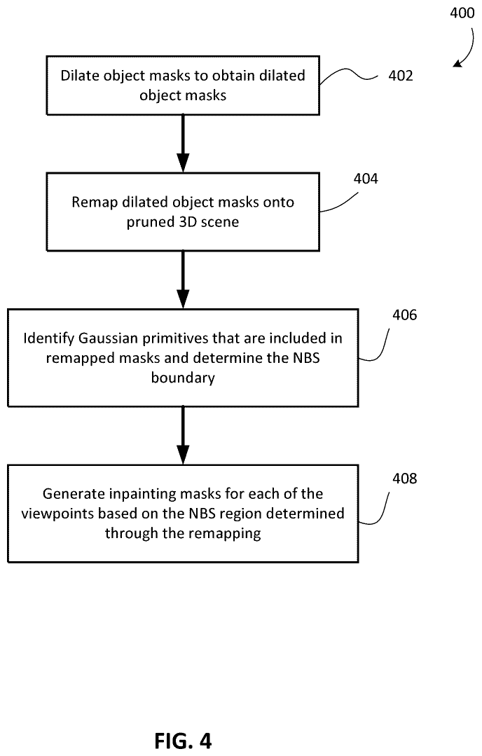

Reference is now made to FIG. 3, which illustrates the process 300 of determining the inpainting mask area and developing inpainting masks, and to FIG. 4, which shows, in flowchart form, an example method 400 for determining the inpainting mask area. The method 400 uses the pruned scene, [symbol] , and the object masks

$${\{ {M}_{n} \}}_{n = 1}^{N} .$$

The object masks are first dilated to enlarge them slightly to create a set of dilated object masks 302. In other words, the masks are expanded so as to including some adjacent or neighbouring pixels. In some implementations, a growth operation may be carried out to grown the mask size. The growth operation may, for example, identify mask boundary pixels and then grow to include adjacent non-masks pixels as new mask boundary pixels over X iterations.

The dilated object masks 302 are then re-mapped back onto the pruned scene with an objective of determining which Gaussian primitives fall within the dilated mask area, as indicated by operation 404. It will be appreciated that a dilated mask mapped to the 3D scene from a viewpoint will include two areas: (1) the actual NBS region in need of inpainting and its surrounding pixels captured by the dilation and (2) an adjacent or surrounding region that may be revealed from this viewpoint but that is well defined in at least some other viewpoints. Using a similar mask mapping process to the one described above for object removal, a learned parameter pₘ may be appended to the Gaussian primitives and over the course of a set of iterations the learned parameter may be updated through the remapping of dilated masks from the various viewpoints in order to learn which pixels (e.g. Gaussian primitives) mark the boundary of the inpainting mask region. That is, in operation 406 the system determines from the remapping which Gaussian primitives make up the boundary of the NBS or inpainting mask region. A set of remapped masks 304 rendered from [symbol] may be determined from thresholding the learned parameter to isolate those Gaussians that define the boundary of the NBS. Those remapped masks 304 indicate the boundary area of the inpainting mask region by identifying the surrounding pixels, as indicated in example images 304a and 304b.

In operation 408, as set of inpainting masks 306 may then be obtained from the set of remapped masks 304. In some cases, a 2D image segmentation model may be used to determine an inpainting mask 306 for each viewpoint based on the remapped mask 304 for that viewpoint. As indicated by images 306a and 306b, the inpainting masks defined the inpainting mask region from that viewpoint.

At this stage, the system has a set of inpainting masks

$${\{ {M}_{n}^{*} \}}_{n = 1}^{N}$$

and corresponding images

$${\{ {I}_{n} \}}_{n = 1}^{N} ,$$

where the images are rendered from the pruned scene [symbol] . One of the views may be selected as a reference view. In some cases, a user input may be used for the selection. In some cases, one of the views or viewpoints may have been previously designated as a “front” or primary view, by user input or by default. For example, in the case of a scene constructed from a series of camera image captures, the first image of the series may be designated as the primary view. In some cases, the reference image may be randomly selected by the system.

Two-dimensional inpainting is applied to the reference image. Any one of a number of image inpainting algorithms or operations may be used. The inpainted reference image may be designated l₁*.

The system then needs to generate an updated pruned scene in which the inpainting appears consistently throughout the various possible viewpoints. To do so, a disentangled two-stage pipeline is used, including geometry reconstruction and multi-view refinement. The geometric reconstruction phase may include a depth prediction based geometric reconstruction within the reference image, and a warping operation to translate inpainting in the reference image to other images or viewpoints.

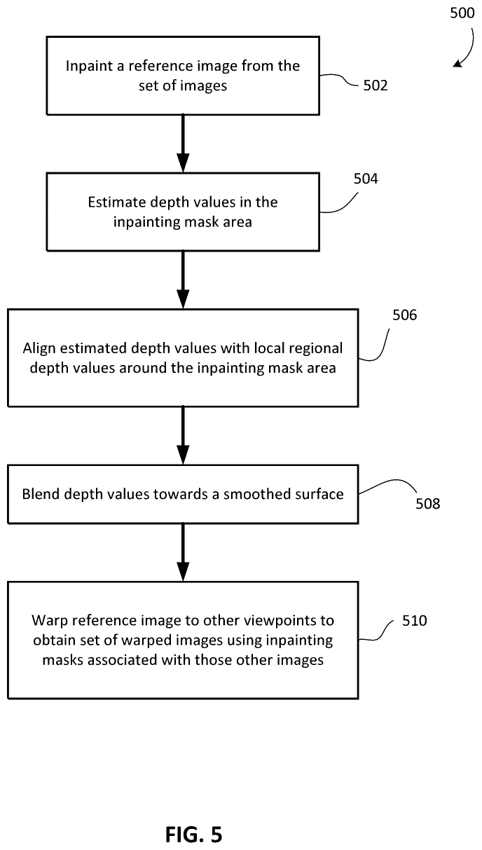

Reference will now be made to FIG. 5, which shows, in flowchart form, one example method 500 of reconstructing geometry in an NBS region. The method 500 begins with inpainting of the reference image in operation 502 to obtain the inpainted reference image. In operation 504, the system then estimates depth values in the inpainting mask area of the reference image.

A set of depths

$${\{ {D}_{n} \}}_{n = 1}^{N} ,$$

may be determined from the pruned scene [symbol] and a truncated signed distance fusion technique used to reconstruct geometry from those depths; however, such as set only contributes to reconstruction of the background region since the depth values within the inpainting mask region are invalid. To complete the geometry for the inpainting mask area, the system seeks to generate an all-valid depth map

$${D}_{1}^{*}$$

for the reference image by filling D₁ based on the inpainted reference image

$${I}_{1}^{*} .$$

The filled depth values need to be consistent with the inpainted reference image

$${I}_{1}^{*}$$

and need to seamlessly connect with the depth values that surround the inpainting mask area.

Accordingly, the depth values within the mask area are first estimated or predicted. In one example, a momencular depth estimator is employed to estimate depth D̅₁̅ from

$${I}_{1}^{*} .$$

As indicated by operation 506, the estimated depth values are then aligned with the depth values in the local region of the inpainting mask area. For instance, a linear transformation may be used to convert estimated depths D̅₁̅ to scene-scale estimated depths [symbol] . In one example, this may take the form: [symbol] =a*D̅₁̅+b, where a and b are compute din the neighbourhood area of the inpainting mask M₁. This may, in some cases, be carried out as a minimization to minimize the difference between D̅₁̅ and D₁ in that region:

$${min}_{a , b} \sum \vert a * \overline{{D}_{1}} + b - {D}_{1} \vert$$

The above expression may be evaluated in the boundary region of the inpainting mask area in some implementations.

As indicated by operation 508, the system may then blend the scene-scale estimated depth values to better smooth the geometry of the inpainted area. This may be referred to as a filling or blending operation. Formally, in at least one case, the filled values

$${D}_{1}^{*}$$

are computed as:

$${D}_{1}^{*} ( x ) = {arg max}_{{D}_{1}^{*}} {\sum }_{x ∈ {M}_{1}} {‖ ∇ {D}_{1}^{*} ( x ) - ∇ \tilde{{D}_{1}} ( x ) ‖}^{2} + λ ∇ {D}_{1}^{*} ( x )$$

$$s . t . {D}_{1}^{*} ( x ) = {D}_{1} ( x ) , x ∉ {M}_{1} .$$

In the above expression, the symbol ∇ denotes a divergence calculation. The conditional notes that values of the filled depth map

$${D}_{1}^{*} ( x )$$

must match the values of the rendered depth map D₁(x) outside of the inpainted mask area. Intuitively, the first term of the above expression encourages the fille depth map

$${D}_{1}^{*} ( x )$$

to maintain a similar changing trend as [symbol] (x), while the second term regularizes

$${D}_{1}^{*} ( x )$$

to be smooth and consistent with the depth pattern or topography outside of the mask.

Once the filled depth map is determined, in operation 510, the inpainted reference image and, in particular, its inpainted mask area may be warped to other viewpoints, thereby generating a set of warped images. The warping of the inpainted reference image to other views may be at least partly based on the inpainting mask image for that other view.

The warping operation may result in some anomalies or artefacts in the other views. Accordingly, the present application employs a multi-view restoration model to refine the warped images.

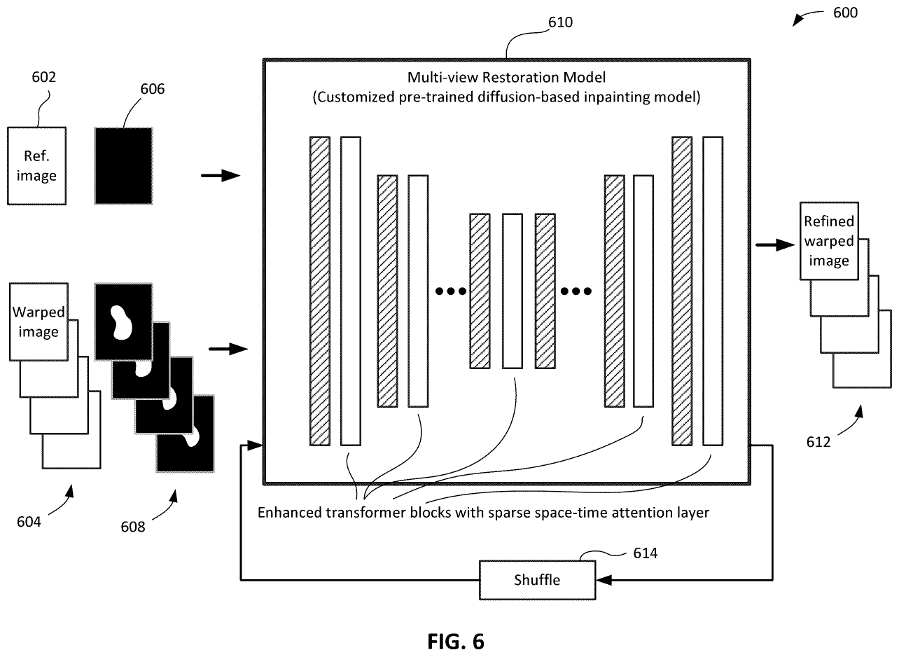

Reference will now be made to FIG. 6, which illustrates an example multi-view restoration process 600. The geometric reconstruction and warping operation operates based on a reference image 602 and results in a set of warped images 604. The warped images 604 are the rendered images

$${\{ {I}_{n} \}}_{n = 1}^{N}$$

from the pruned scene [symbol] from other viewpoints modified based on the warping of the geometrically-reconstructed inpainted region from the reference image 602. The warped images 604 have a set of inpainting masks 608,

$${\{ {M}_{n}^{*} \}}_{n = 1}^{N} ,$$

that define the inpainted region within each of those warped images 604.

The warped images 604, their inpainting masks 608, the reference image 602 and an all-zeros mask 606 of the reference image 602 are input to a multi-view restoration model 610. The multi-view restoration model 610 may be implemented using a customized pre-trained diffusion-based inpainting model. The multi-view restoration model 610 is used to refine the warped images 604 and to output a refined set of warped images 612.

In order to ensure multi-view consistency, the multi-view restoration model 610 is implemented by customizing a pre-trained diffusion-based inpainting model by replacing the self-attention layer of the transformer blocks with a space-time attention layer that enables exploration of correlation across images from different viewpoints. In view of the quadratic complexity of global attention and the large number of warped images in a typical 3D scene, in many embodiments the space-time attention layer is a sparse space-time attention layer. The sparse space-time attention layer may look at correlations between an image and one or more of its neighbouring images (in a given order). The order may be an order of viewpoints around a 3D scene, for instance. The sparse space-time attention layer may be configured to evaluate each image with its two immediately adjacent neighbours. In some cases, the sparse space-time attention layer may be configured to explore each image together with two or more of its neighbouring images and the reference image 602, to ensure alignment with the selected reference image 602.

In one example implementation, during T denoising steps, the order of the warped images 604 may be shuffled 614 to break the sequential constraint of sparse attention and further enhance cross-view consistency. The shuffling may be random in some instances or may be a preset shuffling pattern. In either case, any alteration to ordering of the warped images 604 during processing by the multi-view restoration model 610 is corrected when outputting the refined warped images 612 so that the set of refined warped images 612 is in the correct order.

The customized pre-trained diffusion-based model is fine-tuned through constructing a training dataset. During finetuning, the images

$${\{ {I}_{n} \}}_{n = 1}^{N}$$

may be re-used to create two types of training pairs: consistent and random. The system may randomly select B images as ground truth and apply two different schemes to simulate warping artifacts. For the consistent pairs, consistent masks are generated corresponding to the same 3D location with the help of [symbol] and warp the first image to others, aligning closely with realistic scenarios. To encourage cross-view learning, the system also uses random masks, i.e. irregular masks are generated on each image and image-based augmentations (such as elastic transformations, colour jittering, etc.) are applied to the masked regions. The model is fine-tuned for K₂ iterations using a mixture of both types of pairs, using a simplified variational bound objective.

Once the customized pre-trained diffusion-based model has been finetuned to realize the multi-view restoration model 610, it is used to refine the warped images 604.

Once the refined warped images 612 are obtained from the model 610, the system may then fine-tune or refine the pruned scene [symbol] . The data set of refined warped images 612 and the reference image may be used to fine-tune or refine the pruned scene for K₂ iterations using simple pixel-wise loss, L₁ loss, and/or SSIM loss. Other, more robust, loss functions may be used in other implementations.

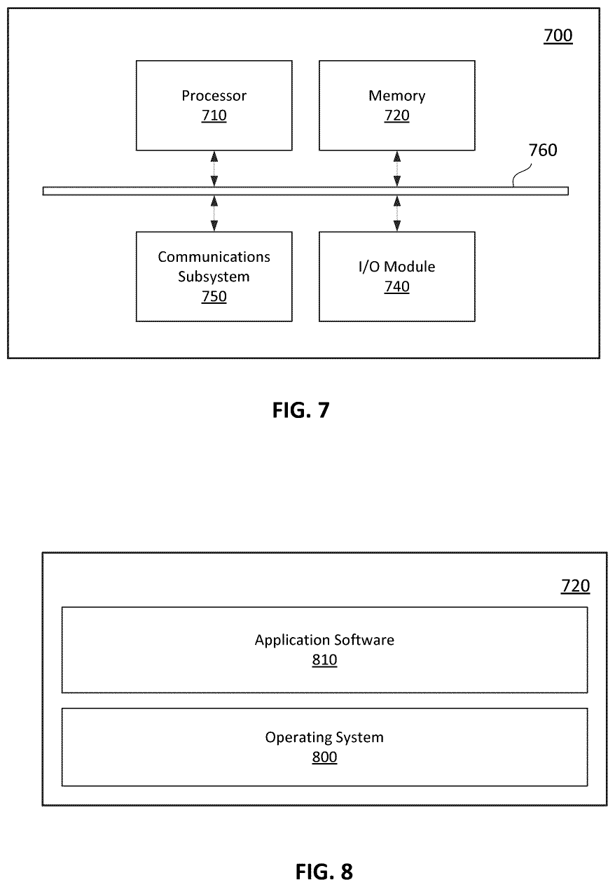

Reference will now be made to FIG. 7, which shows a high-level diagram of an example computing device 700. The example computing device 700 includes a variety of modules. For example, the example computing device 700 may include a processor 710, a memory 720, an I/O module 740, and a communications module 750. As illustrated, the foregoing example modules of the example computing device 700 are in communication over a bus 760.

The processor 710 in this example is a hardware processor. The processor 710 may, for example, be one or more ARM, Intel ×86, PowerPC processors, or the like.

The memory 720 allows data to be stored and retrieved. The memory 720 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 700.

The I/O module 740 allows the example computing device 700 to receive input signals and to transmit output signal. Input signals may, for example, correspond to input received from a user. Some output signals may, for example, allow provision of output to a user. The I/O module 740 may serve to interconnect the example computing device 700 with one or more input devices. Input devices may, for example, include one or more of a touchscreen input, keyboard, trackball or the like. The I/O module 740 may serve to interconnect the example computing device 700 with one or more output devices. Output devices may include, for example, one or more display screens such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers.

The communications module 750 allows the example computing device 700 to communicate with other electronic devices and/or various communications networks. For example, the communications module 750 may allow the example computing device 700 to send or receive communications signals. As an example, the communication module 750 may include a network connection, data port, or the like. Communications signals may be sent or received according to one or more protocols or according to one or more standards. For example, the communications module 750 may allow the example computing device 700 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G, 6G, or the like. Additionally, or alternatively, the communications module 650 may allow the example computing device 700 to communicate using near-field communication (NFC), via Wi-Fi™, via the Ethernet family of network protocols, using Bluetooth™ or via some combination of one or more networks or protocols. In some embodiments, all or a portion of the communications module 750 may be integrated into a component of the example computing device 700. In some examples, the communications module may be integrated into a communications chipset.

Software instructions are executed by the processor 710 from a computer-readable medium. For example, software may be loaded into random-access memory from persistent storage within memory 720. Additionally, or alternatively, instructions may be executed by the processor 710 directly from read-only memory of the memory 720.

FIG. 8 depicts a simplified organization of software components stored in memory 720 of the example computing device 700. As illustrated, these software components include, at least, application software 810 and an operating system 800.

The application software 810 adapts the example computing device 700, in combination with the operating system 800, to operate as a device performing a particular function. While a single application software 810 is illustrated in FIG. 8, in operation, the memory 720 may include more than one application software and different application software may perform different operations.

The operating system 800 is software. The operating system 800 allows the application software 810 to access the processor 710, the memory 720, the I/O module 740, and the communications module 750. The operating system 800 may, for example, be iOS™, Android™, Linux™, Microsoft Windows™, or the like.

The application software 810 and/or operating system 800 may, when executed, cause the processor 710 to carry out operations to implement at least some portion of one or more of the methods described herein.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an embodiment, should be understood to mean that the value, condition or characteristic is defined within tolerances that are acceptable for the proper operation of this embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements. The term “and/or” is intended to indicate that either of the two elements may be included or both of the elements may be included.

A person skilled in the art will understand that embodiments of this application may be provided as a method, an apparatus (or system), a computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It will be understood that a person skilled in the art may make various modifications and variations to this application without departing from the scope of this application. This application is intended to cover these modifications and variations of this application provided that they fall within the scope of protection defined by the following claims and their equivalent technologies.

Throughout the present disclosure, a processor, a processor system, an application processor, a baseband processor, a processor circuit, or a processor core may be collectively referred to as a processor. A processor may include one or more of a central processing unit (CPU), a digital signal processor (DSP), a microprocessor unit (MPU), a microcontroller unit, (MCU), a graphics processing unit (GPU), a field programmable gate array (FPGA), an artificial intelligence (AI) processor, or a neural network processing unit (NPU), or a combination of at least two of these integrated circuit forms.

Throughout the present disclosure, a memory may include one or more of the following storage media: a RAM, a static random access memory (SRAM), a dynamic random access memory (DRAM), a phase-change memory (PCM), a resistive random access memory (ReRAM), a magnetoresistive random access memory (MRAM), a ferroelectric random access memory (FRAM), a cache, a register, a read-only memory (ROM), a flash memory, an erasable programmable read-only memory (EPROM), a hard disk, and/or the like. In an example, the computer program instructions used to execute embodiments contained herein may be stored in a non-volatile memory. When a terminal runs, part or all of corresponding computer program instructions may be loaded into a memory that has a higher transmission speed with a corresponding processor, for example, the instructions may be loaded into at least a part of a memory such that the processor executes the computer program instructions to perform the steps in of embodiments described herein.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A method of object removal for a three-dimensional scene, the method comprising:
pruning a set of Gaussian primitives to remove an object from the three-dimensional scene using object masks from a plurality of viewpoints, thereby producing a pruned set of Gaussian primitives;
re-mapping the object masks from the plurality of viewpoints using the pruned set of Gaussian primitives to determine an inpainting mask area resulting from object removal;
inpainting a reference image from one of the plurality of viewpoints to obtain an inpainted reference image;
reconstructing a geometry within the inpainting mask area of the inpainted reference image;
warping the inpainted reference image to other viewpoints of the plurality of viewpoints to generate a set of warped images;
refining the set of warped images using a multi-view restoration model to produce a set of refined images; and
refining the pruned set of Gaussian primitives using the set of refined images to produce an inpainted set of Gaussian primitives for the three-dimensional scene.

2. The method of claim 1, wherein the re-mapping includes dilating the object masks prior to re-mapping them to the pruned set of Gaussian primitives.

3. The method of claim 2, wherein the re-mapping includes initializing a learnable parameter for each Gaussian primitive that indicates whether its associated Gaussian primitive is included in the inpainting mask area.

4. The method of claim 3, wherein the re-mapping includes rendering each object mask from its associated viewpoint with the pruned set of Gaussian primitives, optimizing across all viewpoints to update the learnable parameter for the Gaussian primitives based on correspondence between each object mask and the Gaussian primitives, and, based on the updated learnable parameters determining which Gaussian primitives from the pruned set of Gaussian primitives define the inpainting mask area.

5. The method of claim 1, wherein reconstructing the geometry within the inpainting mask area of the reference image includes performing a depth prediction within the inpainting mask area and smoothing the depth prediction with depth values in areas adjacent to the inpainting mask area.

6. The method of claim 5, wherein the depth prediction includes using a momencular depth estimator to estimate depths of the inpainting mask area of the inpainted reference image and applying a divergence minimization calculation to smooth the estimated depths with the depth values in areas adjacent to the inpainting mask area.

7. The method of claim 1, wherein warping includes warping the inpainted reference image masked by an inpainting mask selecting the inpainting mask area.

8. The method of claim 1, wherein refining the set of warped images using the multi-view restoration model includes modifying a pre-trained diffusion-based inpainting model to replace a self-attention layer in a transformer block with a space-time attention layer to result in the multi-view restoration model.

9. The method of claim 8, wherein the space-time attention layer is a sparse space-time attention layer that ensures alignment between two or more adjacent ones of the warped images in an order.

10. The method of claim 9, wherein the order of the warped images is shuffled during one or more rounds of inference.

11. The method of claim 8, wherein an input to the multi-view restoration model includes the set of warped images and a corresponding set of inpainting masks defining the inpainting mask area from each of the viewpoints.

12. A system for object removal for a three-dimensional scene, the system comprising:
one or more computing devices having one or more processors and memory, the memory storing processor-executable instructions that, when executed by the one or more processors, are to cause the one or more processors to:
prune a set of Gaussian primitives to remove an object from the three-dimensional scene using object masks from a plurality of viewpoints, thereby producing a pruned set of Gaussian primitives;
re-map the object masks from the plurality of viewpoints using the pruned set of Gaussian primitives to determine an inpainting mask area resulting from object removal;
inpaint a reference image from one of the plurality of viewpoints to obtain an inpainted reference image;
reconstruct a geometry within the inpainting mask area of the inpainted reference image;
warp the inpainted reference image to other viewpoints of the plurality of viewpoints to generate a set of warped images;
refine the set of warped images using a multi-view restoration model to produce a set of refined images; and
refine the pruned set of Gaussian primitives using the set of refined images to produce an inpainted set of Gaussian primitives for the three-dimensional scene.

13. The system of claim 12, wherein the processor-executable instructions, when executed by the one or more processors, are to re-map at least in part by dilating the object masks prior to re-mapping them to the pruned set of Gaussian primitives.

14. The system of claim 13, wherein the processor-executable instructions, when executed by the one or more processors, are to re-map at least in part by initializing a learnable parameter for each Gaussian primitive that indicates whether its associated Gaussian primitive is included in the inpainting mask area.

15. The system of claim 14, wherein the processor-executable instructions, when executed by the one or more processors, are to re-map at least in part by rendering each object mask from its associated viewpoint with the pruned set of Gaussian primitives, optimizing across all viewpoints to update the learnable parameter for the Gaussian primitives based on correspondence between each object mask and the Gaussian primitives, and, based on the updated learnable parameters determining which Gaussian primitives from the pruned set of Gaussian primitives define the inpainting mask area.

16. The system of claim 12, wherein the processor-executable instructions, when executed by the one or more processors, are to reconstruct the geometry within the inpainting mask area of the reference image at least in part by performing a depth prediction within the inpainting mask area and smoothing the depth prediction with depth values in areas adjacent to the inpainting mask area.

17. The system of claim 16, wherein the depth prediction includes using a momencular depth estimator to estimate depths of the inpainting mask area of the inpainted reference image and applying a divergence minimization calculation to smooth the estimated depths with the depth values in areas adjacent to the inpainting mask area.

18. The system of claim 12, wherein the processor-executable instructions, when executed by the one or more processors, are to warp at least in part by warping the inpainted reference image masked by an inpainting mask selecting the inpainting mask area.

19. The system of claim 12, wherein the processor-executable instructions, when executed by the one or more processors, are to refine the set of warped images using the multi-view restoration model at least in part by modifying a pre-trained diffusion-based inpainting model to replace a self-attention layer in a transformer block with a space-time attention layer to result in the multi-view restoration model.

20. The system of claim 19, wherein the space-time attention layer is a sparse space-time attention layer that ensures alignment between two or more adjacent ones of the warped images in an order.

21. The system of claim 20, wherein the order of the warped images is shuffled during one or more rounds of inference.

22. The system of claim 19, wherein an input to the multi-view restoration model includes the set of warped images and a corresponding set of inpainting masks defining the inpainting mask area from each of the viewpoints.

23. A non-transitory computer-readable medium storing processor-executable instructions for object removal for a three-dimensional scene that, when executed by one or more processors, are to cause the one or more processors to:
prune a set of Gaussian primitives to remove an object from the three-dimensional scene using object masks from a plurality of viewpoints, thereby producing a pruned set of Gaussian primitives;
re-map the object masks from the plurality of viewpoints using the pruned set of Gaussian primitives to determine an inpainting mask area resulting from object removal;
inpaint a reference image from one of the plurality of viewpoints to obtain an inpainted reference image;
reconstruct a geometry within the inpainting mask area of the inpainted reference image;
warp the inpainted reference image to other viewpoints of the plurality of viewpoints to generate a set of warped images;
refine the set of warped images using a multi-view restoration model to produce a set of refined images; and
refine the pruned set of Gaussian primitives using the set of refined images to produce an inpainted set of Gaussian primitives for the three-dimensional scene.
